(19) United States
(12) Patent Application Publication
(10) Pub. No.: US 2005/0245681 A1
(43) Pub. Date: Nov. 3, 2005

(54) Rubberized walk surface formulation

(76) Inventors: William L. McGrath, Spring Lake, NJ (US); Paul Zwick, League City, TX (US)

Correspondence Address: Charles I. Brodsky, 2 Bucks Lane, Marlboro, NJ, 07746, US

(21) Appl. No.: 10/834,319

(22) Filed: Apr. 29, 2004

(51) Int. Cl. C08L 53/00

(52) U.S. Cl. 525/88

(57) ABSTRACT

A rubberized walk surface formulation applyable by manual or machine troweling atop old or cracked concrete as well as wood, metal and/or fiberglass surfaces, including a formulation of thermoplastic pebbles in a 100% solid moisture-cured aliphatic urethane binder.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to a rubberized formulation for covering a walk surface or for recovering a walk surface that has been damaged over time. As will be appreciated, such formulation can be used at patios and pool, decks, at driveways and sidewalks, and at step and playground surfaces.

2. Description of the Related Art

As is well known and understood, such granulated synthetic rubber surfaces as Ethylene Propylene Diaene Monomer (EPDM) have found frequent use in surfacing applications alongside swimming pools and playgrounds. Ground up from sheets, these vulcanized rubber granules are then typically mixed with a urethane or epoxy to be troweled onto the surface floor. While providing greater safety than concrete, wood, metal and fiberglass surfaces, these rubber pieces, however, break down relatively fast under ultraviolet light—to the extent of even turning “white” within just a few weeks of placement. With available sunlight tending to break down the rubber itself, the associated surface then becomes brittle, leading to quick disintegration. In playground and swimming pool areas, the usual “fix” is just to sweep away the broken pieces and resurface the area every few years. Alternatively, a spraying may be done with a pigmented urethane every one-two years, with the urethane having various rubber fines in it in an attempt to bind the surface back together. Using trowels and lubricating solvents to smooth the repaired surface quickens the break down process, however, as the EPDM granules are attacked by the types of sprays employed. With these vulcanized rubber pieces being totally unrecyclable, the disintegrated pieces can only be trucked to a landfill and dumped.

Because of this recognition that temperature and weather can have a deleterious effect upon these surfaces—and that their recovering is both very expensive and often deteriorates the original surface even more—, experience has shown it to be more cost effective to completely remove the damaged surface to begin with, and to install a new one in its place.

### SUMMARY OF THE INVENTION

As will become clear from the following description, the rubberized walk surface formulation of the present invention can be used in an initial installation of a safety surface as well as to be installed as a recovering of damaged or cracked concrete, wood, metal or fiberglass. Besides being comfortable to walk upon, testing has shown that the rubberized floor surface remains flexible in extreme hot and cold climates, and resists fading or discoloring to the equivalent of over 20 years of exposure to ultraviolet sunlight; in addition to affording a decorative look that adds to the life of the substrate floor, the rubberized formulation is one that can be hand or power troweled into place.

In seeking to develop this formulation as an alternative to the ground EPDM synthetic granules used for surfacing, it was desired to provide a more ultraviolet resistant, color stable, and chemical resistant rubber that would perform better in outdoor use and would be applied without the dangers of harsh chemicals now used for troweling lubricants. Eliminating the need of hand troweling on one's knees, while having a re-surfacing rubber that does not chalk or degrade yet gives years of use without annual maintenance, were all objectives as well. As ultimately realized with the present invention, focus was first placed upon the use of thermoplastic rubbers along with polyurethane binders to bond the thermoplastic rubbers together. As most resins do not bond to plastic, the challenge became one to create a thermoplastic rubber that the liquid urethane binder system would adhere to. Although Styrenic Blocked Copolymer Compositions looked attractive, it was found that they were very olefin in nature so that, by themselves, there was little to no adhesion.

Through analysis and testing, a rubberized walk surface formulation was developed which can be manually and/or machine troweled upon concrete, wood, metal, fiberglass and shredded EPDM rubber surfaces. The formulation, according to the invention, includes a mixture of aliphatic thermoplastic urethane combined with an acrylate styrene acrylonitrile (ASA) trepolymer with functional carboxylic groups, a first thermoplastic compound of tri-block copolymer composition from the group including styrene, ethylene, butadiene and isoprene, and a second thermoplastic compound of maleated styrene, ethylene, butylene and styrene block copolymer. In such formulation, the styrene is polymerized into a first block (or large segment), and the ethylene, butadiene or isoprene is attached and polymerized into a second block; to function as an elastomer, another styrene block is added or attached to the opposite end of the ethylene, butadiene or isoprene block, to form the tri-block copolymer of resilient and elastic characteristic. With the ethylene, butadiene or isoprene mid-block being further hydrogenated, the resultant block copolymer becomes fully saturated so as to be much more ultraviolet resistant.

In preferred embodiments of the invention, additives or modifiers are included to enhance functionality and to aid in the reduction of cost. Calcium carbonate is added as a filler to increase the density of the material; mineral oil is added as a plasticizer to modify the softness/hardness of the formulation. Other ingredients can be added to the formulation to provide other features—such as to protect the polymers from oxidation, to protect the polymers during extrusion processing, to protect the polymers from heat distortion, to control color stability and to resist attack from ultraviolet sun rays.

As will be described more completely below, such features are obtained by adding just trace amounts of these modifiers beyond the aliphatic thermoplastic urethane and ASA combination, the first and second groupings of thermoplastic compounds, and the filler and mineral oil ingredients. In preferred embodiments of the invention, formulations employing the aliphatic thermoplastic urethane combination by weight of up to 10% with 10% ASA, the first thermoplastic compound by weight of up to 10% and the second thermoplastic compound by weight of up to 5% of the mixture perform quite well. With a calcium carbonate filler of 50% by weight of the mixture and a mineral oil plasticizer of some 16% by weight, perfectly achievable results follows with the employment of the aliphatic thermoplastic urethane and ASA combination, the first thermoplastic compound, and the second thermoplastic compound of 20%, 10% and 5% by weight, respectively. Together, the polymer oxidizing preventer, the polymer heat deterioration preventer, the ultraviolet absorber and the light stabilizer may then total approximately 1% by weight of the mixture.

With this formulation, its described method of manufacture, and its described use of application when poured or spread out onto a new or damaged surface and allowed to cure, a permanent, seamless, crack and slip-resistant surface then follows.

### BRIEF DESCRIPTION OF THE DRAWINGS

These and other features of the present invention will be more clearly understood from a consideration of the following description, taken in connection with the accompanying drawings, in which:

FIG. 1 is a block diagram illustrative of a method of applying the rubberized formulation of the invention on an existing substrate or subsurface, whether cracked or otherwise damaged, or not; and

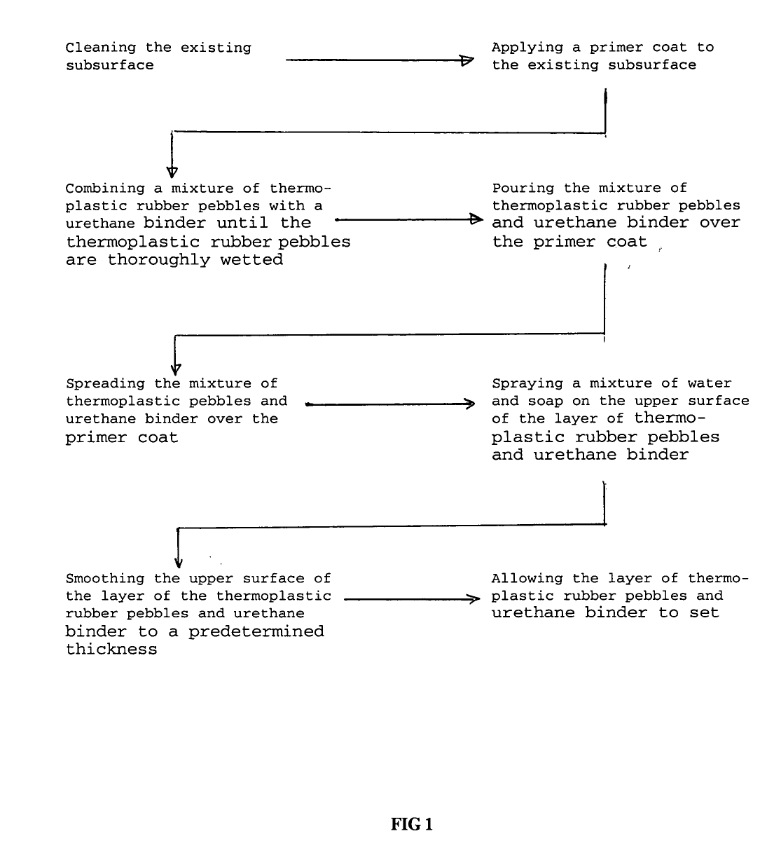

FIG. 2 is a side-cutaway view of the formulation in place.

### DETAILED DESCRIPTION OF THE INVENTION

The rubberized walk surface formulation of the invention—hereinafter referred to as a “Pebble-Flex” formulation—comprises a mixture of the following:
1. an aliphatic thermoplastic urethane combined with an acrylate styrene acrylonitrile (ASA) trepolymer with functional carboxylic groups, of between 5%-20% by weight;
2. a tri-block copolymer composition from the group including styrene, ethylene, butadiene and isoprene, 7.5%-40% by weight; and
3. A maleated polymer composition from the group including styrene, ethylene, butylene and styrene block copolymer, 5%-20% by weight.
   Preferably, the formulation also includes a 2-3 micron calcium carbonate filler to increase the density of the formulation (0%-60% by weight) and a high viscosity mineral oil to modify the softness/hardness of the formulation (4.5%-30% by weight). The calcium carbonate filler and the high viscosity mineral oil make the formulation functional and add to a reduction in the cost of its manufacture.

In a preferred formulation, the following percentages by weight have proved optimum:
1. Aliphatic thermoplastic urethane—10%;
2. Acrylate styrene acrylonitrile—10%;
3. Tri-block copolymer composition—9.70%;
4. Maleated polymer—5%;
5. Calcium carbonate filler—50%; and
6. Mineral oil plasticizer—14.50%.
   Further additives or modifiers may include polyolefins, stabilizers, lubricants and other polymers. The polyolefins are added to enhance the processability of the formulation; the stabilizers are added to protect the polymer during processing and end use; and the lubricants are added to enhance the processability further. A phenolic antioxidant of 0.10% by weight in the preferred embodiment protects the polymer from oxidation; a phosphate stabilizer, also of 0.10% by weight, protects the polymer during the process of the below described extrusion process; a disteary L-thiodipropionate of 0.20% by weight protects the polymer from heat distortion. A benzotriazole ultraviolet absorber aids in ultraviolet light resistance as well as to control color stability when added by weight to the extent of 0.20%, while an amine light stabilizer added also by weight of 0.20% further aids against ultraviolet attack and color degradation.

A preferred procedure for processing the two thermoplastic compounds is as follows: the tri-block copolymer composition rubber powder is pre-blended with mineral oil in a high intensity batch mixer (i.e., a ribbon blender) until homogeneous and dry to the touch; then, the maleated polymer composition is added to the blend, either in the batch mixer or separately at different locations of a twin-screw extrusion-mixing device. The twin-screw extruder or mixer is used for heating, melting and mixing all ingredients in a high shear environment, and is equipped with continuous feeders that meter the ingredients, that provide vacuum vending, and that provide liquid injection if needed. Side feeders to meter the filler material into the mixing vessel are preferred, along with heated barrels and a pelletizer to convert the mixed materials into a compact, solid pebble. An underwater pelletizer is then utilized, equipped with a die head of different sized holes to generate a distribution of pebble diameters. The temperatures involved are in the 350° F.-400° F. range, with a mixing time adjustable from 20 seconds to 120 seconds. The pebbles are then run through a dryer and cooler to prevent them from fusing together as they cool. The pebbles may then be bagged into separate 50 pound bags.

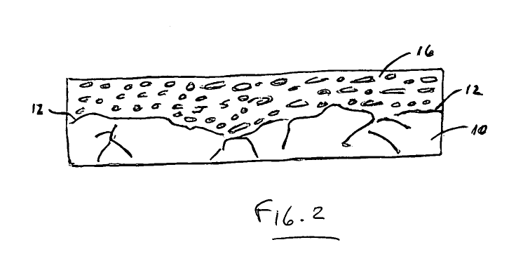

In FIG. 2, the area to be resurfaced or overlaid with the safety surface formulation of the invention is shown as 10, as a concrete driveway, concrete patio or concrete pool deck or an asphalt driveway or playground surface. The existing surface 10 for example, may have become uneven and cracked, and presents either a safety hazard or is aesthetically unpleasing.

The first step with respect to the installation of the formulation as a resurfacing material would be to clean the area to be covered to remove all dirt, oils and grease. This cleaning can be accomplished by washing the area with common household detergent, and then thoroughly hosing off the area to be covered with water. For extremely dirty or mildewed concrete, the area should advisably be power washed clean.

Once the area has been cleaned, an epoxy primer 12 is applied to its top surface. The primer can be applied by a paint roller or brush, and should be applied to the top surface within 15 minutes so as to prevent its premature hardening. Such primer may consist of a mixture of bisphenol and epichlorodydrin epoxy resin along with a hardener such as modified polyamidoamine. Once the primer 12 has been applied to the area to be resurfaced, and before it has an opportunity to harden, and while it is still damp, the rubberized walk surface formulation of the invention 16 is applied as a cover. In such an installation, 100 pounds of the pebbles may be mixed with one gallon of 100% solid aliphatic urethane in a mortar mixer, or by hand in a wheelbarrow. While the primer is still wet, the entire mixed material can be dumped onto the primed area and raked out in a size of approximately 80 square feet. A clean soapy water is lightly misted over the installation, and troweled smooth either by hand or with a power troweling machine. When done by hand, an installer can use a common garden rake to spread the mixture evenly over the premeasured area, and to then use a regular masonry trowel to smooth and level the area to a thickness of approximately 3/8 inch. Once the area has been smoothed to the desired thickness, a spray bottle filled with water and a mild liquid soap may be gently sprayed on the upper surface of the applied area and on the trowel, with the trowel being continued drawn across the surface until completely smooth. As the pebbles and binder are designed to be moisture cured, the use of the water in this manner causes the surface to set, so that the more water used, the more rapid the setting.

Once the 80 square foot area has had the pebbles and binder resurfacing material applied and treated, it should be allowed to cure approximately 24 hours, or until the surface is dry to the touch.

As will be appreciated by those skilled in the art, the thermoplastic rubber pebble composition is specifically formulated to set with the urethane binder in this manner, and to be moisture cured; this presents an effective and relatively easy method of resurfacing damaged areas—or could be employed simply as a safety surface over any type of base—whether of shredded EPDM rubber, or otherwise. A tenacious bond results with this surfacing system that will be understood to prevent against ultraviolet degradation and against thermal shock from extreme hot or cold temperature. Flexibility at both high and low temperatures continues, along with the absence of heat distortion. While improved performance can still be had over presently employed installations of utilizing vulcanized rubber products without the ultraviolet stabilizer or the light absorber stabilizer of the formulation, such small additives further insure against fading and degradation so as to permit the “Pebble-Flex” formulation to provide its degree of protection without any measurable fading or discoloring over a period of time determined to be equivalent to substantially 20 years of exposure to ultraviolet sunlight.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the invention.

1. A rubberized walk surface formulation comprising:
a mixture of aliphatic thermoplastic urethane combined with an acrylate styrene acrylonitrile trepolymer with functional carboxylic groups, a first thermoplastic compound of tri-block copolymer composition from the group including styrene, ethylene, butadiene and isoprene, and a second thermoplastic compound of maleated polymer composition from the group including styrene, ethylene, butylene and styrene block copolymers.

2. The formulation of claim 1 wherein said aliphatic thermoplastic urethane combination comprises up to 20% by weight of said mixture.

3. The formulation of claim 1 wherein said mixture also includes a high viscosity mineral oil plasticizer.

4. The formulation of claim 3 wherein said high viscosity mineral oil plasticizer comprises up to 30% by weight of said mixture.

5. The formulation of claim 1 wherein said mixture also includes a calcium carbonate filler.

6. The formulation of claim 5 wherein said calcium carbonate filler comprises up to 50% by weight of said mixture.

7. The formulation of claim 1 wherein said first thermoplastic compound comprises up to 10% by weight of said mixture.

8. The formulation of claim 1 wherein said second thermoplastic compound comprises up to 5% by weight of said mixture.

9. The formulation of claim 3 wherein said mixture also includes a calcium carbonate filler.

10. The formulation of claim 9 wherein said mixture also includes at least one of a polymer oxidizing preventer, a polymer heat deteriorating preventer, an ultraviolet light absorber, and a light stabilizer.

11. The formulation of claim 9 wherein said mixture also includes a polymer oxidizing preventer, a polymer heat deteriorating preventer, an ultraviolet light absorber, and a light stabilizer.

12. The formulation of claim 1 wherein said mixture includes said aliphatic thermoplastic urethane combination by weight of 5%-20% of said mixture, said first thermoplastic compound by weight of 7.5%-10% of said mixture, and said second thermoplastic compound by weight of 5%-20% of said mixture.

13. The formulation of claim 5 wherein said mixture includes said aliphatic thermoplastic urethane combination by weight of 20% of said mixture, said first thermoplastic compound by weight of 9.70% of said mixture, said second thermoplastic compound by weight of 5% of said mixture and calcium carbonate filler by weight 50% of said mixture.

14. The formulation of claim 5 also including a high viscosity mineral oil plasticizer, wherein said mixture includes said aliphatic thermoplastic urethane combination by weight of 5%-20% of said mixture, said first thermoplastic compound by weight of 7.5%-10% of said mixture, said second thermoplastic compound by weight of 5%-20% of said mixture, calcium carbonate filler by weight 0%-60% of said mixture, and high viscosity mineral oil plasticizer by weight of 4.5%-30% of said mixture.

15. The formulation of claim 14 wherein said mixture includes said aliphatic thermoplastic urethane combination by weight of 20% of said mixture, said first thermoplastic compound by weight of 9.70% of said mixture, said second thermoplastic compound by weight of 5% of said mixture, calcium carbonate filler by weight 50% of said mixture, and high viscosity mineral oil plasticizer by weight of 14.50% of said mixture.

16. A rubberized resurfacing preparation for an existing walk surface comprising:
a first primer coat layer applied to said existing walk surface;
and a second layer overlying said first layer comprising a mixture of aliphatic thermoplastic urethane combined with an acrylate styrene acrylonitrile trepolymer with functional carboxylic groups, a first thermoplastic compound of tri-block copolymer composition from the group including styrene, ethylene, butadiene and isoprene, and a second thermoplastic compound of maleated polymer composition from the group including styrene, ethylene, butylene and styrene block copolymers.

17. The preparation of claim 16 wherein said second layer also includes a calcium carbonate filler and a mineral oil plasticizer.

18. The preparation of claim 17 wherein said mineral oil plasticizer is of a viscosity to allow hand and/or machine troweling of said second layer atop said first primer coat layer.

19. The preparation of claim 17 wherein said second layer is applied to a depth of substantially 3/8 inch atop said first layer.

20. The preparation of claim 17 wherein said second layer also includes at least one of a polymer oxidizing preventer, a polymer heat deteriorating preventer, an ultraviolet absorber, and a light stabilizer.
